(19) United States
(12) Patent Application Publication
(10) Pub. No.: US 2025/0138257 A1
(43) Pub. Date: May 1, 2025

(54) SYSTEMS, SETUPS, UNITS AND METHODS FOR BEAM PROFILE MODIFICATION

(71) Applicant: ELBIT SYSTEMS ELECTRO-OPTICS - ELOP LTD., Rehovot (IL)

(72) Inventors: Zeev SCHIFFER, Rehovot (IL); Daniel LEVY, Rehovot (IL)

(21) Appl. No.: 19/007,499

(22) Filed: Jan. 1, 2025

Related U.S. Application Data
(63) Continuation of application No. PCT/IL2023/050685, filed on Jul. 3, 2023.

(30) Foreign Application Priority Data
Jul. 4, 2022 (IL) 294523

(51) Int. Cl. G02B 6/42

(52) U.S. Cl. CPC G02B 6/4206

(57) ABSTRACT

A modification setup including an array of modification units, each positioned and configured to: cause light of an input optical beam to pass through a corresponding input surface of the respective modification unit, in a manner that reduces exceeding of its light, from a first effective aperture of the input surface; and modify beam profile of the input optical beam, to form an intermediate optical beam having a beam profile of illumination distribution factor that is higher than that of the input optical beam. An output surface of the modification unit, located at a distance D from the input surface is configured and positioned such that the intermediate optical beam passes through the output surface at increased illumination cover area and decreased exceeding from a second effective aperture of the output surface. Each input beam may be collimated before entering the input surface of a corresponding modification unit.

### FILED OF THE INVENTION

The present disclosure relates in general to optical systems, setups and methods for modification of beam profile of one or more optical beams and more specifically to modification of beam profiles of optical beams for improving far field performances of coherent beam combining systems.

### BACKGROUND

Beam shaping is typically defined as modification of a spatial profile of an optical beam. A spatial profile (also called “beam profile”) of an optical beam can be defined as a spatial distribution of the intensity/power/energy of the optical beam, typically over a plane that is traverse (e.g., perpendicular) to a propagation path of the optical beam.

Multi-channel systems such as beam combining systems are typically designed to combine multiple optical beams, emanating from multiple light sources such as from one or more laser diodes e.g., guided through multiple laser fibers (in which case, the light source location is defined as the output end of the fiber), into a single far field (FF) “combined beam”. FF performances of the combined beam, which may include FF energy/intensity spatial distribution, are dependable, inter alia, on near field (NF) beam profiles of the optical beams being combined.

In beam combining systems, such as CBC systems, using input optical beams of same/similar wavelengths, the beam combining performances are typically associated with the FF energy/intensity distribution of the combined beam, where optimal beam combining performances are equivalent to minimum FF spatial energy distribution (achieving a single spot at the FF traverse plane with minimum achievable spot size) and maximum energy concentration (minimum energy losses dependable, inter alia, on maximum constructive interference of the input beams at the FF distance). These combined-beam performances/quality measure is typically called “power in the bucket” (PIB).

A near field (NF) distances range or zone can be defined as the range of distances from the light source location, in which the Fresnel number is larger than a threshold number F0 that is equal to or close to 1, while a far field (FF) distances range can be defined as a distances range in which the Fresnel number of the beam is lower than the threshold F0, where a Fresnel number is a dimensionless parameter defined by:

F=(a²/Lλ)

Wherein: “a” is a size of an effective aperture of the beam (such as an effective aperture diameter size or width); “L” is the distance between the light source and a traverse plane from which the Fresnel number is measured; and “λ” (Lambda) is the wavelength of the beam.

The above estimation of a FF threshold is typically used as a rough estimation and is more accurate when the distance from the light source is significantly larger than the aperture size “a”.

### SUMMARY

Aspects of disclosed embodiments may pertain to a modification setup for modification of beam profiles of multiple coherent input optical beams, the modification setup comprising at least:

an array of modification units, each modification unit being positioned and configured at least to:

cause light of a corresponding input optical beam to pass through a corresponding input surface of the respective modification unit, in a manner that reduces exceeding of light of the corresponding input optical beam, from a first effective aperture of the corresponding input surface;

modify beam profile of the corresponding input optical beam, to form an intermediate optical beam having an intermediate beam profile that has an illumination coverage factor that is higher than that of the corresponding input optical beam, wherein an output surface of the corresponding modification unit, having a second effective aperture, is located at a distance D from the input surface of the corresponding modification unit such that the corresponding intermediate optical beam passes through the corresponding output surface at increased illumination cover area and decreased exceeding of the corresponding second effective aperture of the corresponding output surface; and

output multiple modified output optical beams of reduced beam-overlap and increased illumination coverage area at a near filed (NF) traversing plane.

Other Aspects of disclosed embodiments, pertain to a method for modification of beam profiles of multiple coherent input optical beams, the method comprising at least:

providing an array of modification units, each modification unit having an input surface with a first effective aperture and an output surface with a second effective aperture, wherein each output surface is located at a distance D from its corresponding input surface;

causing light of each input optical beam to pass through a corresponding input surface of a corresponding modification unit, in a manner that reduces exceeding of light of the corresponding input optical beam, from a corresponding first effective aperture of the corresponding input surface;

modifying beam profile of each input optical beam, to form an array of intermediate optical beams, each intermediate optical beam having an intermediate beam profile that has an illumination coverage factor that is higher than that of its corresponding input optical beam, each intermediate optical beam is passed between from the input surface to the output surface of the corresponding modification unit such that the intermediate optical beam passes through the corresponding output surface at increased illumination cover area and decreased exceeding of the corresponding second effective aperture of the corresponding output surface; and

outputting multiple modified output optical beams of reduced beam-overlap and increased illumination coverage area at a near filed (NF) traversing plane.

Other Aspects of disclosed embodiments, pertain to a modification unit for modification of beam profile of an input optical beam, the modification unit comprising at least:

a first optical mask configured and located o cause an input optical beam to pass through an input surface thereof, in a manner that reduces exceeding of light of the corresponding input optical beam, from a first effective aperture of the corresponding input surface and to modify beam profile of the passed input optical beam, to form an intermediate optical beam having an intermediate beam profile that has an illumination coverage factor that is higher than that of the corresponding input optical beam; and

a second optical mask having an output surface with a second effective aperture, that is located at a distance D from the input surface of the corresponding modification unit such that the intermediate optical beam passes through the output surface of the second optical mask at increased illumination cover area and decreased exceeding of the second effective aperture.

Yet other aspects of disclosed embodiments pertain to a method for modification of beam profiles of input optical beams, the method comprising at least:

providing at least one modification unit having an input surface with a first effective aperture and an output surface with a second effective aperture, wherein each output surface is located at a distance D from its corresponding input surface;

causing light of each input optical beam to pass through a corresponding input surface of a corresponding modification unit, in a manner that reduces exceeding of light of the corresponding input optical beam, from a corresponding first effective aperture of the corresponding input surface;

modifying beam profile of each input optical beam, to form a corresponding intermediate optical beam having an intermediate beam profile that has an illumination coverage factor that is higher than that of its corresponding input optical beam, each intermediate optical beam is passed between from the input surface to the output surface of the corresponding modification unit such that the intermediate optical beam passes through the corresponding output surface at increased illumination cover area and decreased exceeding of the corresponding second effective aperture of the corresponding output surface; and outputting multiple modified output optical beams of reduced beam-overlap and increased illumination coverage area at a near filed (NF) traversing plane.

### BRIEF DESCRIPTION OF THE FIGURES

The figures illustrate generally, by way of example, but not by way of limitation, various embodiments discussed in the present document.

The number of elements shown in the Figures should by no means be interpreted as limiting and is for illustrative purposes only

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. References to previously presented elements are implied without necessarily further citing the drawing or description in which they appear. The figures are listed below.

FIGS. 1A and 1B show two different situations in which a diffraction-limited optical beam is passed through an aperture and the effect of each situation on far field (FF) beam performances: FIG. 1A shows an input optical beam having a Gaussian beam profile being truncated by an aperture, causing the FF beam PIB performances to reduce by forming “ripples” in the FF beam; and FIG. 1B shows an input optical beam having a Gaussian beam profile that is too narrow in comparison to the aperture, causing the FF beam PIB performances to reduce by causing the FF beam energy to be distributed over a too-large spot size;

FIG. 2 shows a “single-channel” optical setup that uses a modification setup for modifying a diffraction-limited input optical beam, according to some embodiments;

FIG. 3 shows a “single-channel” optical setup that uses a modification setup for modifying a diffraction-limited input optical beam, according to some embodiments;

FIG. 4 shows a “multi-channel” optical setup, for a coherent beam combining (CBC) system that uses a modification setup for modifying multiple coherent diffraction-limited input optical beams, according to some embodiments;

FIG. 5 shows a “single-channel” optical setup that uses a monolithic modification setup for modifying a diffraction-limited input optical beam, according to some embodiments;

FIG. 6 shows a “multi-channel” optical setup, for a coherent beam combining (CBC) system that uses a monolithic or semi-monolithic modification setup for modifying multiple coherent diffraction-limited input optical beams, according to some embodiments;

FIGS. 7A-7C show simulated images for beams of a CBC system: FIG. 7A shows energy distribution in a near field (NF) plane of multiple beams having a Gaussian beam profile of a first Gaussian order GO=1 arranged in a hexagonal configuration; FIG. 7B shows energy distribution in a NF plane of multiple beams having a Gaussian beam profile of a Gaussian order GO=10 (super-Gaussian) arranged in a hexagonal configuration; and FIG. 7C shows a FF energy distribution of a combined beam of combined multiple beams of FIG. 7B having a super-Gaussian beam profile;

FIGS. 8A-8C show a first diffractive phase mask/diffractive optical element (DOE) design, according to some embodiments: FIG. 8A shows a spatial phase-distribution (phase-profile) of a Gaussian beam once converted by the first phase mask of the modification unit (near the output surface of the first phase mask); FIG. 8B shows an isometric 3D view of the phase-distribution (phase-profile) near the output surface of the first phase mask; and FIG. 8C shows a physical embossment/engraving design of the first phase mask.

FIGS. 9A-9C show a second diffractive phase mask/DOE design, according to some embodiments: FIG. 9A shows a spatial phase-distribution (phase-profile) of an intermediate beam of super Gaussian beam profile once converted by the second phase mask of the modification unit (in the NF, close to the output surface of the surface phase mask); FIG. 9B shows an isometric 3D view of the phase-distribution (phase-profile) near the output surface of the second phase mask; and FIG. 9C shows a physical embossment/engraving design of the second phase mask.

FIG. 10 shows simulated graphs showing phase vs. radial distance from a main radial axis of the first and the second phase masks, according to some embodiments;

FIG. 11 shows a cross section of a super-Gaussian beam profile energy distribution;

FIGS. 12A and 12B show a multi-channel modification setup that also uses a customized passive or active correction array for correcting one or more optical aberrations of the input beams, according to some embodiments: FIG. 12A shows a separated modification setup in which a correction array is separately positioned in respect to the array of modification units; and FIG. 12B shows a monolithic modification setup, according to some embodiments;

FIG. 13 shows a schematic illustration of a CBC system that uses a “multi-channel” modification setup, for FF combined beam performances improvement, according to some embodiments;

FIG. 14 shows a flowchart of a method/process for modification of multiple input optical beams, according to some embodiments;

FIG. 15 shows a flowchart of a method/process for modification of at least one input optical beam, according to some embodiments;

FIG. 16 shows a cross sectional view of different beam profiles: a super Gaussian profile, an M-shaped cross section profile, and a Gaussian of a low Gaussian order profile, according to some embodiments;

### DETAILED DESCRIPTION OF SOME EMBODIMENTS

Aspects of disclosed embodiments, aim, inter alia, to minimize natural unwanted diffraction effects which frequently occur, when using diffraction-limited optical beams, due to limited aperture dimensions.

Delivering a beam of light (herein also “optical beam” or “beam”) through an aperture usually implies optical truncation of a “tail” of the beam at the ‘near Field plane’ (NFP), which affects both NFP loss and Far-Field plane (FFP) divergence. By applying setups, methods, systems and/or subsystems of disclosed embodiments, on a Gaussian (“diffraction-limited”) incoming (input) beam, the truncation effect is mitigated, to improve achievable FFP power in the bucket (PIB) beam quality performances, especially, yet not exclusively, for implementations including beam combining of multiple input beams.

High Performance of an optical system, especially where high input beam(s) energy is involved, requires considerations of diffraction effects on the beams along their passage. For example, in case of a perfect “single mode” (SM) beam, then Intensity beam profile at a NFP can be given by:

$${I}_{beam} ( r ) = {I}_{beam} \cdot {exp}^{- ( 2 {r}^{2} / {σ}_{beam}^{2} )} \qquad ( 1 )$$

Where σ_{beam} is the Gaussian beam radius, defined as the radius of the circle, at which Intensity drops to e⁻² (13.5%) of its maximum value, at beam center. FFP angular distribution IFF-beam (θ) and angular diameter θ div are given by:

$${I}_{ff - beam} ( θ ) = {I}_{beam} {exp}^{- ( {20}^{2} / {θ}_{div}^{2} )} \qquad ( 2 )$$

$${θ}_{div} \approx 4 {λ}_{beam} / π {D}_{beam} \qquad ( 3 )$$

Where θ_{div} is full-angle, Far-Field plane (FFP) divergence at e 2. A_{beam}=2σbeam is beam near-field Diameter. The above expressions is given for a ‘perfect’ or ‘ideal’ Gaussian beam.

The term ‘perfect/ideal Gaussian’ pertains to a beam that is unlimited or nearly unlimited by any aperture size/width/diameter. However, in cases of real-life physical apertures, a laser beam passing through such an aperture is never again ‘perfect/ideal’ in that sense.

According to diffraction physical laws, for a given physical aperture of size (e.g., width/diameter) A1 having a Gaussian beam profile having power P_{beam}, passing through it, there should be a trade-off between the actual divergence of the outputted beam (outputted from the aperture) and the amount of beam-power blocked by that aperture. For example, if we chose to minimize power loss, by using a narrow Gaussian beam (σbeam-1<<A), then its divergence will be typically larger than it would have been, if we chose an input beam of a wider width σbeam-2>σbeam-1.

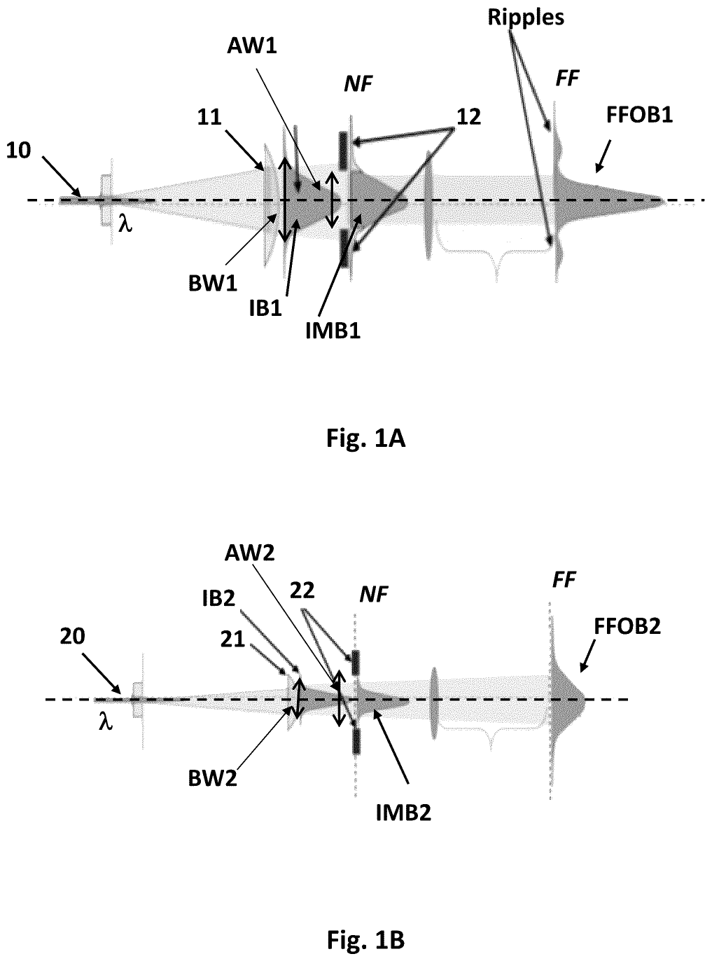

FIG. 1A, for example, shows an initial input optical beam IB1, that emanates from an output end of an optical fiber 10 and collimated by collimator 11, that has a Gaussian beam profile and beam width BW1, when passing through an aperture 12 of an aperture width AW1 that is larger than the aperture width AW1 (AW1<BW1). In this case, the input beam IB1 is truncated by the aperture and an output optical beam resulting therefrom, at a far field (FF) plane location FFOB1, will have a beam profile that includes a main or central lobe and one or more ripple lobes surrounding it. This will result in increased divergence of the FF output beam FFOB1 and/or a dramatic power loss and low FF PIB, as the energy/power FF spatial distribution of the original input beam will be spread (distributed) over a much larger area of a FF traverse plane and/or the energy in the central lobe will be much lower than the overall initial input beam IB1 power. The larger the portion of the input beam BII rim being truncated, the more ripples and power/energy losses will be caused.

FIG. 1B, shows a different case, in which the initial input optical beam IB2, emanating from an output end of an optical fiber 20 and collimated by collimator 21, has a beam width BW2, when passing through an aperture 22 of an aperture width AW2 that is smaller than the aperture width AW2 (AW2>BW2). In this case, the input beam IB2 is not truncated by the aperture and an output optical beam resulting therefrom, at a far field (FF) plane location FFOB2, will have a beam profile that includes a single main lobe with no ripples or a lobe with much smaller (lower energy) and/or lower number of ripples. However, the diameter/width of the FFOB2 will be too wide for some implementations and will result also in a too low PIB as the energy will be spread/distributed over a too-large area at a traverse FF plane.

Using any one of the cases shown in FIGS. 1A and 1B, will result in a substantive power loses and beam divergence both at the NF and at the FF planes, possibly reaching a minimum total power loss of a about 13% of the initial total beam power of the input beam.

Furthermore, when using a multi-channeled system such as a coherent beam combining (CBC) system for combining multiple input optical beams having same or similar wavelengths, in which each of the input beams are passed through different one or more optical elements that present a limited aperture per-input beam, the FF performances of the combined optical beam may suffer from a dramatically increased beam divergence and/or power losses of the combined beam at a traverse FFP.

Aspects of disclosed embodiments, pertain to optical setups, methods, systems and subsystems that are designed to improve or optimize far field (FF) performances of a single or multiple optical beams by enabling mitigation of diffraction effects in the near field (NF).

Aspects of disclosed embodiments pertain to a modification setup for modification of beam profiles of multiple coherent input optical beams, the modification setup that may include at least: an array of modification units, each modification unit being positioned and configured at least to:

cause light of a corresponding input optical beam to pass through a corresponding input surface of the respective modification unit, in a manner that reduces exceeding of light of the corresponding input optical beam, from a first effective aperture of the corresponding input surface;

modify beam profile of the corresponding input optical beam, to form an intermediate optical beam having an intermediate beam profile that has an illumination coverage factor that is higher than that of the corresponding input optical beam,

wherein an output surface of the corresponding modification unit, having a second effective aperture, is located at a distance D from the input surface of the corresponding modification unit such that the corresponding intermediate optical beam passes through the corresponding output surface at increased illumination cover area and decreased exceeding of the corresponding second effective aperture of the corresponding output surface; and

output multiple modified output optical beams of reduced beam-overlap and increased illumination coverage area at a near filed (NF) traversing plane.

The term “illumination distribution factor” referred to herein can be defined as:

a filling factor of the optical beam; or

a parameter that is inversely proportional to a spatial intensity/energy variance of the optical beam. This means that the higher the illumination distribution factor is—the lower its energy/intensity spatial variance.

One object of proposed embodiments is to achieve beam modification of each input optical beam that increases its illumination distribution factor and therefore decreases its original energy/intensity spatial variance.

In order to modify each input optical beam such as to increase its illumination distribution factor, the modification unit may be configured to form an intermediate optical beam with a flat-top beam profile, a flat-top annular ring profile, a semi-super Gaussian profile having a M-shaped cross section, or a super-Gaussian profile.

According to some embodiments, the output surface of the corresponding modification unit may be located at a distance D from the input surface of the corresponding modification unit such that light of the corresponding intermediate optical beam, is passed through the corresponding output surface in a manner that reduces/prevents/minimizes exceeding of light of the corresponding intermediate optical beam, from an output (second effective) aperture border of the output surface. Each modification unit of the modification setup may be further configured to output a radially symmetrical corresponding output optical beam of a higher illumination distribution factor that corresponds to the size of the second effective aperture of the output surface of the corresponding modification unit and that is also optionally collimated in the NF by the modification unit. This may enable improving FF beam combining performances such as higher power in the bucket (PIB) value/rate, by enabling to achieve, in the NF, an array of output optical beams (outputted from the modification setup) of minimized/reduced/non overlap therebetween (due to the fitting of the intermediate and output beam to the second effective aperture border of their corresponding modification unit), and maximized/increased effective illumination area per output optical beam.

In some embodiments, each of the input optical beams may have a Gaussian or semi/pseudo Gaussian beam profile of a first Gaussian order GO1, such as a full Gaussian profile, a Bessel function profile with one or more ripples (side rings) that are of significantly lower overall energy/power than that of a main lobe of the input beam, and the like.

According to some embodiments, each modification unit of the modification setup may be configured to convert each input optical beam of a Gaussian/semi-Gaussian beam profile of a first Gaussian order GO1 (defined by its spatial energy distribution and/or perimeter slope) into an output optical beam of a Gaussian/semi-Gaussian beam profile of a higher Gaussian order GO2 (e.g., where GO2 is at least 4 orders above GO1 i.e., has a much higher spatial energy distribution and higher beam profile perimeter slope).

According to other embodiments, each modification unit of the modification setup may be configured to convert each input optical beam of a Gaussian/semi-Gaussian beam profile of a first Gaussian order GO1, into an M-shaped beam profile cross-section, such as a beam profile that has an inner lowered-energy central lobe or an inner central extremum/minimum energy/intensity peak (examples will be shown in detail below).

According to some embodiments, the input surface of each modification unit may include a first optical mask such as a first phase mask and/or a first diffractive mask that may be configured to modify phase spatial distribution of the incoming input optical beam.

According to some embodiments, the output surface of each modification unit may include a second optical mask such as a second phase/diffractive mask, configured for example to collimate the intermediate optical beam impinging thereof or passed therethrough, and optionally also for further modifying spatial phase distribution of the corresponding intermediate optical beam.

According to some embodiments, the first effective aperture of each modification unit may be defined as an aperture of the first optical mask.

Additionally or alternatively, the second effective aperture of each modification unit may be defined as an aperture of the second optical mask of the respective modification unit or the overall size of a fragment that includes the output surface of the corresponding modification unit.

According to some embodiments, any one or more of: the input optical beam, the intermediate optical beam and/or the output optical beam may have a radial symmetry.

According to some embodiments any one of the first and/or second optical masks may also be radially symmetrical, defining a radially symmetrical first and/or second effective apertures.

The size and/or shape of the first effective aperture may be equivalent (same) as the size and/or shape of the second effective aperture of each modification unit of the modification setup.

Aspects of disclosed embodiments, pertain to a modification setup for modification of beam profiles of multiple coherent input optical beams, the modification setup may include an array of modification units, each modification unit being positioned and configured to modify beam profile of each incoming input optical beam, having an initial beam profile of a Gaussian/semi-Gaussian of a first Gaussian order GO1, such that the corresponding input optical beam is modified into an output optical beam having a beam profile of a Gaussian or a semi-Gaussian of a second Gaussian order GO2, which is higher than the first Gaussian order GO1 of the beam profile of the corresponding input optical beam.

The term “modification” or “beam modification” or any conjugation thereof, used herein, may pertain to any type of manipulation of an optical beam including one or more of: beam shaping, beam collimation, beam spatial expansion/convergence, wavefront manipulation, beam phase distribution manipulation, beam intensity/energy spatial distribution manipulation, etc.

According to some embodiments, the modification setup may be configured such that the output optical beams, outputted therefrom, are of minimized overlap therebetween and maximized spatial energy distribution, at a near field (NF) plane traversing the propagation path of the output optical beams.

According to some embodiments, achieving NF minimum overlap and maximal spatial energy distribution of the outputted output beams in a NFP, the modification units of the (optical) modification setup may include at least:

a first array (FA) comprising multiple first modification segments, each first modification segment of the FA being positioned to have a different incoming input optical beam passed therethrough such that the spatial energy distribution of an initial beam profile of the corresponding input optical beam is maximally distributed over a surface area of an effective aperture A1 of the corresponding first modification segment of the FA and causes minimum truncating of the corresponding input optical beam, the corresponding first modification segment being further configured to modify the corresponding input optical beam such as to form an intermediate optical beam having a beam profile of a Gaussian of a second Gaussian order GO2, which is higher than the first Gaussian order GO1 of the corresponding input optical beam, when the intermediate optical beam reaches specific formation-distance “d” from an output surface of the first modification segment; and

a second array (SA) comprising multiple second modification segments, each second modification segment of the SA being positioned in respect to a corresponding first modification segment at a distance D that is equal to or larger than the formation-distance “d” such that the intermediate optical beam passes therethrough when its spatial energy distribution of its intermediate beam profile is maximally distributed over a surface area of an effective aperture A2 of the corresponding second modification segment of the SA and with minimum truncating thereof by the corresponding second effective aperture A2, each second modification segment being configured to modify a corresponding intermediate optical beam such as to output a collimated output optical beam of an output beam profile of a Gaussian of the second Gaussian order GO2.

According to some embodiments, the effective aperture of the first and/or the second modification segments may not have a radial symmetry and may actually be polygonal or semi-polygonal such as a square, a rectangle or a hexagon. Since all the input/intermediate/output beams have radial symmetry in the NF plane(s), the modification segments may be positioned such that each of the input/intermediate beam passed therethrough will imping an input surface thereof at its maximal intensity/energy distribution with minimum or no truncating thereof at the border (effective aperture) of the respective modification segment.

Embodiments described herein aim to mitigate at least the following typical problems occurring in single or multichannel systems:
1. NF and/or FF power/energy losses occurring due to beam periphery blocked by finite physical aperture (NFP); and/or
2. elevated divergence of output beam(s) caused by abrupt beam “cut”/“truncating” (diffraction effect or FFP “ripples”).

Both of these affecting outcomes may be mitigated simultaneously, by conversion of the input optical beam(s) such that the beam profile of each input optical beam is passed through at least one optical mask with a limited effective aperture with no or negligible NFP blocking loss or abrupt amplitude step along beam profile, while the energy distribution of the input beam is mostly (maximally) distributed and confined within an input area of an input surface of the optical mask having the limited aperture Almitigating thereby both power and divergence affects.

The terms “optical beam(s)” and ‘beam(s)” may be interchangeably used herein pertaining to any electromagnetic beam(s).

The term “power in the bucket” (PIB) used herein may refer to the ratio between the energy distribution/concentration over an area of a traversing FF plane such that an optimal PIB is that of maximum energy/power/intensity distributed over a minimum FF plane area.

The term “beam profile” represents spatial energy/power/intensity distribution.

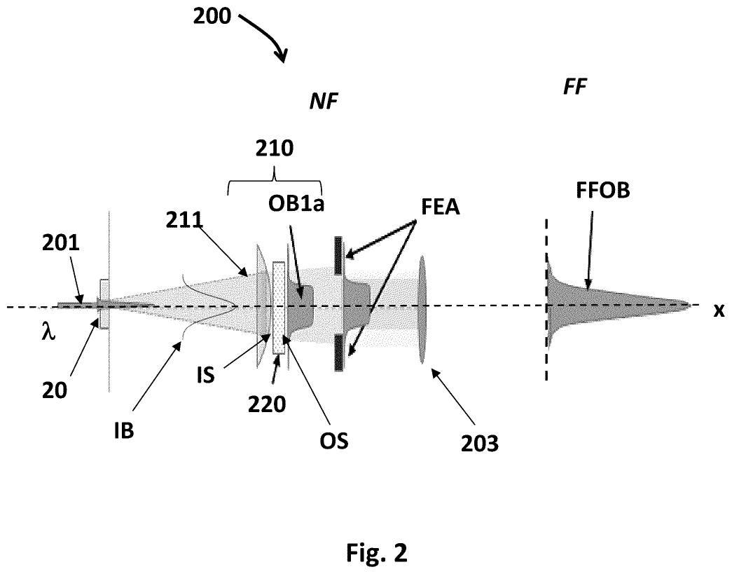

Reference is now made to FIG. 2, schematically illustrating an optical setup 200 that uses a modification setup 210 having a collimator 211 and a modification unit 220, according to some embodiments.

The optical setup 200 includes an optical fiber 201 outputting an input optical beam of a narrow wavelength band peaking at a specific known wavelength 2 (Lambda), and a modification setup 210 including a collimator 211 and the modification unit 220, where the collimator 211 is positioned between the light source (defined as the output end of the optical fiber 201) and the modification unit 220, such that the input optical beam impinging an input surface IS of the modification unit 220 is collimated. The input optical beam IB impinging the input surface IS of the modification unit 220 may have a beam profile with radial symmetry such as a Gaussian beam profile of a first Gaussian order GO1 such as order 1 or 2.

According to some embodiments, the modification unit 220 is positioned and configured to convert/modify/shape the input optical beam IB such as to output an output optical beam OB which has a beam profile with a maximal spatial energy distribution (e.g., maximally spatially distributed in a uniform energy distribution over a specific desired confined area bordered by a final effective aperture FEA). For example, the modification unit 220 may convert/modify the input optical beam IB, which has a beam profile of a Gaussian of the first order GO1 into an output beam having a Gaussian beam profile of a second Gaussian order GO2 that is significantly higher than the first Gaussian order GO1 of the input optical beam IB, for example an output optical beam which is a super Gaussian (SG) of Gaussian order that is above GO=4.

According to some embodiments, the final effective aperture FEA may be the aperture of an output surface OS of the modification unit 220 itself and or any final aperture defined by other elements and/or requirements of the optical setup or a system it is used thereby. For example, if the modification unit 220 is part of an array of modification units used in a coherent beam combining (CBC) system the final effective aperture FEA may be defined by the borders between adjacent output optical beams in the NF plane, in which case, the final effective aperture FEA should be defined as such that will prevent the output beams from overlapping in the NF plane.

According to some embodiments, the modification unit 220 may be positioned such, e.g., in respect to the position of the collimator 211 and the spatial energy distribution of the input beam once it has passed the collimator 211, that the entire or maximum achievable energy/light of the input optical beam IB is passed through an input aperture of an input surface IS of the modification unit 220 in a manner that prevents the energy/light of the input beam IB (as much as achievable) from exceeding border (input aperture IA) of the input surface IS.

The optical setup 200 as described above, will result in an output optical beam OB, at the NF plane, of light that is optimally spatially distributed over an area that is bordered by the final effective aperture FEA, while being maximally confined within that area (i.e. minimal or not exceeding the bordering final effective aperture FEA), which will enable achieving an optimal/improved PIB of a FF optical output beam FFOB resulting from the NF output optical beam OB, where the FF output beam FFOB will have a beam profile of maximized spatial energy concentration and minimized energy losses from the initial energy of the input optical beam IB.

In order for the modification unit to convert an input optical beam of a Gaussian beam profile of a lower first Gaussian order GO1 into an output optical beam having a Gaussian profile of a second (e.g., much) higher Gaussian order GO2 such as into a super-Gaussian, the modification unit may use two diffractive segments: a first diffractive segment, located and serving as an input surface of the modification unit and a second diffractive segment located and serving as an output surface of the modification unit, such that input beam will first pass the first modification segment and then the second modification segment. The first and second modification segments may be implemented as two separated optical elements (such as diffractive optical elements (DOEs)) or as optical masks embossed or engraved over opposite (e.g., parallel) sides of a single monolithic piece, where the first modification segment is embossed/engraved over the input side of the modification unit and the second modification segment is embossed/engraved over the output side of the modification unit.

The optical setup 200 may additionally include one or more additional optical elements such as an additional element 203 which may be an additional collimator or focusing lens for further manipulating the output beam OB in the NF area.

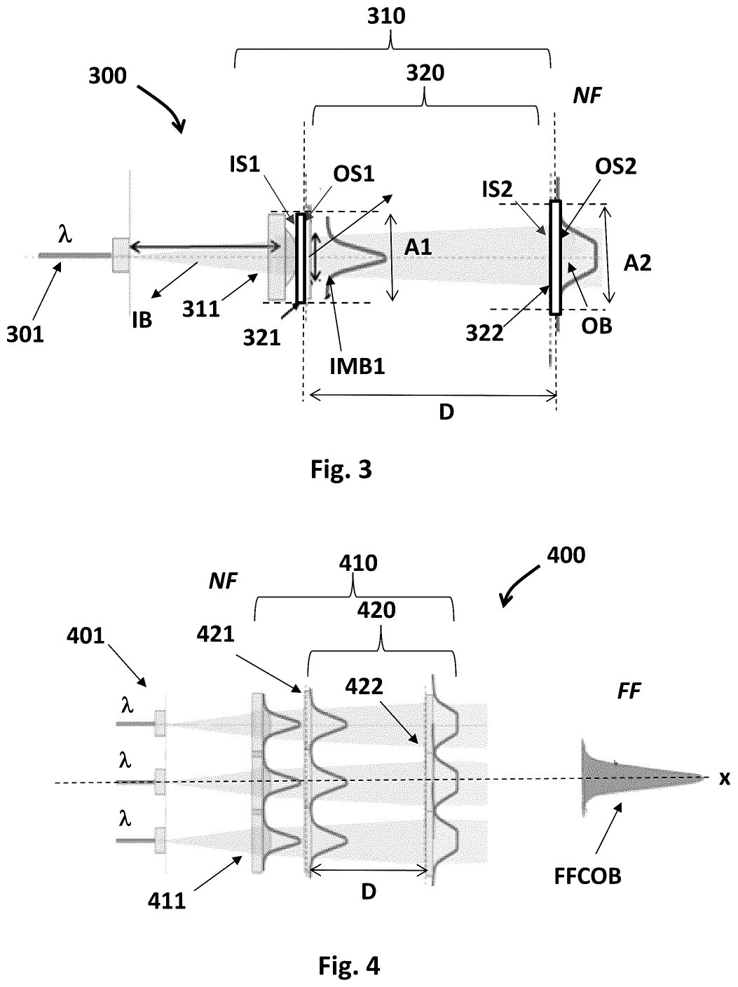

FIG. 3 shows an exemplary embodiment of an optical setup 300 that uses a modification setup 310 having a modification unit 320 that uses two spaced and separate DOEs 311 and 312 for modification of an input beam IB.

The optical setup 300 incudes at least:

The modification setup 310 that includes the modification unit 320 and a collimator 311;

an optical fiber 301 outputting light from an output end thereof forming the initial input optical beam IB; and

one or more additional optical elements e.g., for additional output beam collimation, focusing, and/or correction.

According to some embodiments, the modification unit 320 includes two diffractive optical elements: a first DOE 321 and a second DOE 322, which may be parallel and optically aligned with the input optical beam IB.

The collimator 311 of the modification setup 310 may be used to prevent the input optical beam IB from spatially expanding and to generate a collimated input optical beam IB that has a planar (flat) wavefront, before it enters/impinges the first DOE 321 of the modification unit 320. The first DOE 321 is located such that when the collimated input optical beam IB impinges an input surface IS1 thereof, it is not or minimally truncated by bordering aperture of the first DOE 321.

The first DOE 321 may include a phase mask (e.g., embossed/engraved over an input side of the DOE 321) that is designed to spatially change phases of the input optical beam IB to transform the input optical beam IB into an intermediate optical beam IMB that gradually changes as it propagates away from an output surface of the first DOE 321, due to phase differences over its wavefront, into an intermediate optical beam IMB having a Gaussian or semi-Gaussian beam profile of increased Gaussian order GO2 than that of the input optical beam IB, when reaching or exceeding a formation-distance “d” that is required for its evolving into an intermediate optical beam of a higher (e.g., super) Gaussian beam profile. Therefore, the first and second DOEs 321 and 322 may be located at a distance D from one another, which may be equal or higher than a formation-distance “d” required to produce an intermediate optical beam IMB of a Gaussian beam profile of the second (higher) Gaussian order GO2 at that distance D from the first DOE 321.

The formation distance “d” may be dependent on the wavelength (WL) (or peak wavelength) λ (Lambda) of the input optical beam IB and the first aperture A1 of the first optical mask, proportional to A1²/λ.

According to some embodiments the intermediate optical beam IMB is also expended as it propagates from the first DOE 321 to the second DOE 322.

According to some embodiments, the second DOE 322 may include a second phase mask (e.g., embossed, engraved over an input side thereof) positioned and configured such as to further modify the intermediate optical beam IMB to output a collimated output optical beam OB that has a beam profile of a Gaussian of the second (higher) Gaussian order GO2>GO1 and a planar wavefront at the NF plane.

In order to achieve a Gaussian output optical beam OB at the NF area that has a beam profile of a higher second Gaussian order GO2 and that is collimated and has a planar wavefront, the location of the second DOE 322 should also be such that the intermediate optical beam IMB impinges an input surface IS2 of the second DOE 322 such that the light of the intermediate optical beam IMB is most evenly and maximally spatially distributed over the input surface area IS2 of the second DOE 322, preventing the light from exceeding bordering aperture of the second DOE 322. Furthermore, the second DOE 322 may include a phase mask designed for collimating the intermediate optical beam IMB as well as reverse/stop at least some of the spatial phase conversion done by the first DOE 321 to achieve a planar wavefront.

An output surface area OS2 of an output surface of the second DOE 322 may match the input surface IS2 of the second DOE 322.

According to some embodiments, the input and output surface of the first and second DOEs 321 and 322 may all be equal.

According to other embodiments the input and output surfaces IS1 and OS1 of the first DOE 321 may each be smaller than any one of the input or output surface IS2 and OS2 of the second DOE 322.

Reference is now made to FIG. 4, schematically illustrating a multi-channel optical setup 400 for CBC of multiple coherent input optical beams, according to some embodiments.

The multi-channel optical setup 400 may include at least:

a fiber array 401 that includes N number of optical fibers, each outputting an input optical beam of a WL λ (Lambda); and

a multi-channel modification setup 410 that includes:
a collimation array (CA) 411 comprising an array of at least N collimators; and
a modification array 420 comprising an array of N modification units, the modification array 420 being located after the collimation array 411 in respect to beams propagation direction.

According to some embodiments, the modification array 420 may include two segmented arrays:
(i) a first array (FA) 421, including at least N number of first modification segments each first modification segment (FMS) including a first optical (e.g., diffractive/phase) mask, where the FMSs of the FA are arranged in a packed tiled manner, adjacent to one another; and
a second array (SA) 422, including at least N number of second modification segments each second modification segment (SMS) including a second optical (e.g., phase/diffractive) mask, where the SMSs of the SA are arranged in a packed tiled manner, adjacent to one another.

According to some embodiments, each FMS of the FA 421 is distant from a corresponding SMS of the SA 422 at a same distance D, which is equal to or larger than the formation-distance “d” (which depends on the WL λ of the input optical beams).

Each FMS of the FA 421 is designed and positioned to have maximum light of a corresponding incoming input optical beam to be passed therethrough (e.g., preventing truncating or causing minimum truncating of the corresponding input optical beam). Each FMS may be configured to modify the corresponding input optical beam such as to form an intermediate optical beam having a beam profile of a Gaussian of a second Gaussian order GO2, which is higher than the first Gaussian order GO1 of the corresponding input optical beam, when the corresponding intermediate optical beam reaches a specific formation-distance “d” from an output surface of the corresponding FMS.

Each SMS of the SA 422 may be positioned in respect to a corresponding FMS of the FA 421 such that the corresponding intermediate optical beam passes therethrough when its spatial energy distribution of its intermediate beam profile is maximally distributed (e.g., distributed as evenly as achievable) over a surface area of the corresponding SMS bordered by a corresponding effective aperture A2 and with minimum truncating thereof by the corresponding second effective aperture A2 of the corresponding SMS of the SA 422. Each SMS may be configured to modify a corresponding intermediate optical beam such as to output a collimated output optical beam having a planar (flat) wavefront and an output beam profile of a Gaussian of the second Gaussian order GO2.

The above-described configuration of the optical setup 400 is aimed at enabling improving at least FF PIB performances (beam quality) of the resulting combined optical beam in the FF area (the FF combined beam indicated in FIG. 4 as FFCOB) and reducing NF and FF energy losses.

The resulting group of output optical beams (referred to herein as NF combined optical beam) that are of a Gaussian beam profile of the second Gaussian order GO2 are outputted optimally parallel to one another and with minimum overlap and maximum filling areas therebetween.

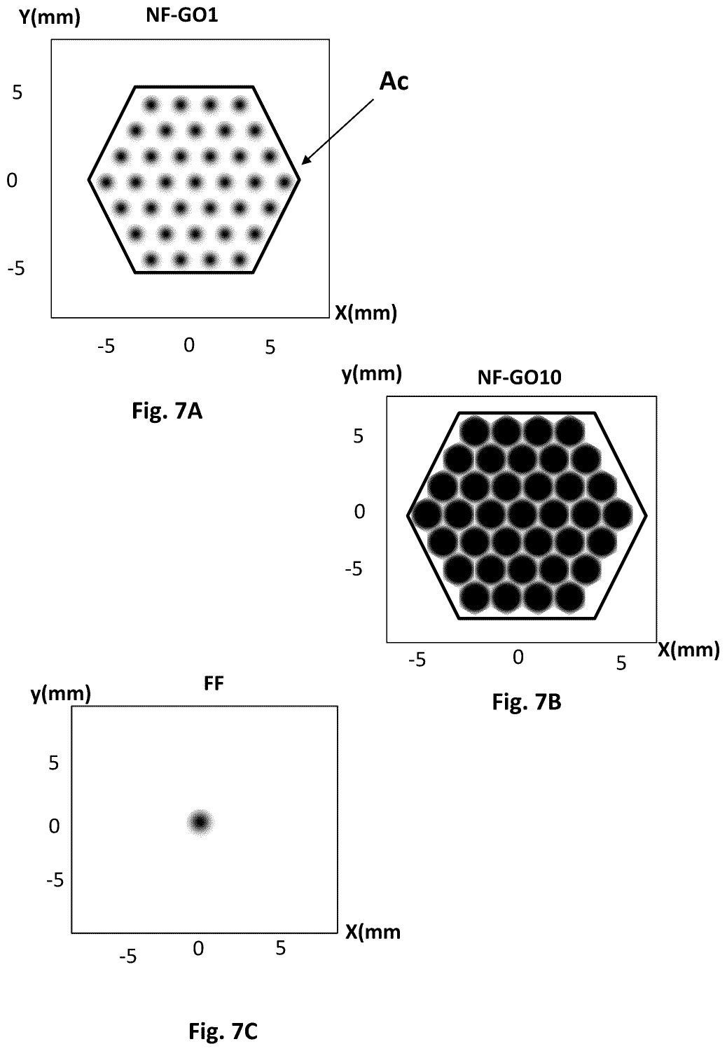

The input/intermediate/output optical beams may be arranged in any desired formation in the NF, such as a hexagonal formation (as shown in FIGS. 7A-7B), a concentric rings formation, a matrix formation etc.

To further improve FF performances of the outputted combined optical beam FFCOB for the CBC system, of the CBC system, one or more additional subsystems/devices/elements may be used such as, for example, one or more of:
(i) at least one additional optical element positioned in the NF or FF after the modification array 420, that further modifies the output optical beams (NF) or combined optical beam FFCOB (FF) in order to: mitigate FF beam performances deficiencies e.g., caused due to intensity/power-reduced gaps formed due to the radial symmetry of the output optical beams, outputted from the modification array 420, and/or focus or collimate the output optical beams/FF combined optical beam;
(ii) a customized correction subsystem including one or more correction arrays positioned: between the fiber array 401 and the collimation array 411, between the collimation array 411 and the modification array 420, or after the modification array 420, configured and positioned for per-channel mitigation of one or more errors or aberrations caused, for example, due to any one or more of: misalignment errors (erroneous alignment) between segments of two or more of any of the arrays 401, 411, 421, FA, SA, element(s) manufacturing errors, deformation and/or imperfections, phase/wavefront errors, etc.
(iii) one or more feedback subsystems using one or more sensing and signal/data processing means and optionally one or more additional optical means, for controllable measuring and matching/adjusting phases and/or polarizations of the input optical beams;

The CBC system may include or use other subsystems, elements and/or arrays such as:

at least one array of collimators (collimation array (CA) for collimating the input optical beams before impinging the modification units of the modification setup;

a phase control/locking subsystem for real time or near real time measuring phase of each of the output and/or the input optical beams, and real time or near real time adjusting phase of each input optical beam, based on its corresponding measured real time or near real time measured phase;

a beam steering subsystem for phased array or mechanical based steering of the combined optical beam; one or more optical elements for combining and/or for focusing the output optical beams, outputted from the modification setup;

one or more optical elements for directing light illuminated by the one or more light source into each of the optical fibers;

a polarization control/locking subsystem for real time or near real time measuring polarization of each of the output and/or the input optical beams, and real time or near real time adjusting polarization of each input optical beam, based on its corresponding measured real time or near real time measured polarization.

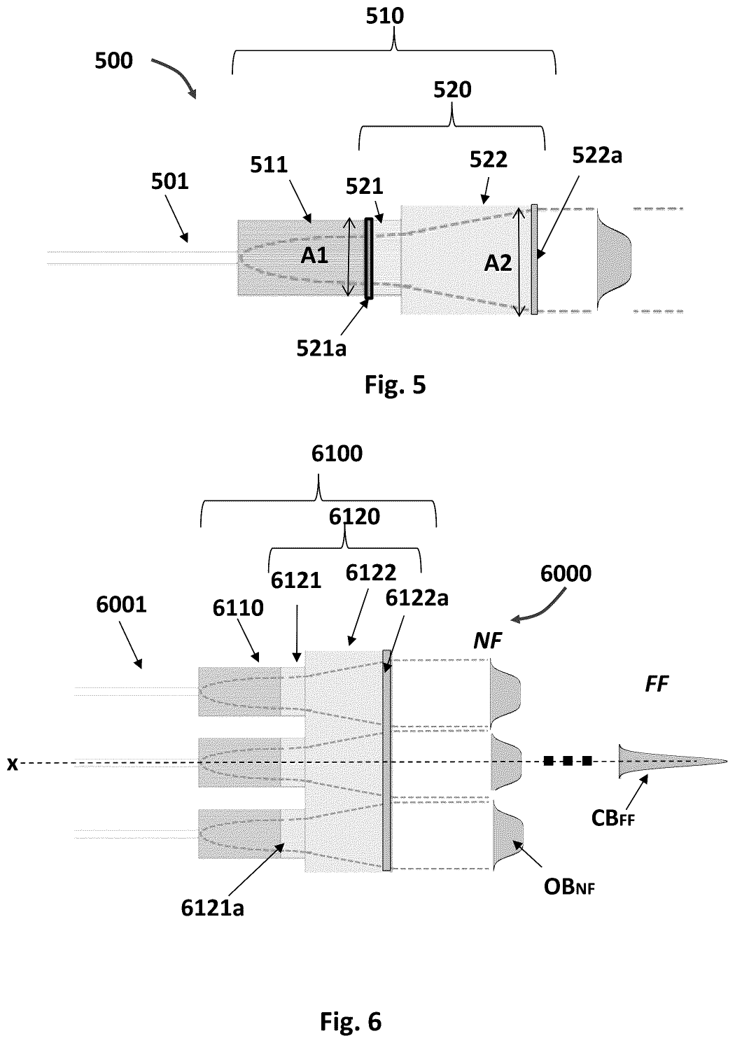

FIG. 5 shows a single-channel optical setup 500, according to some embodiments. The optical setup 500 may include at least:
(a) an optical fiber 501; and
(b) a single-channel monolithic modification setup 510 that may include at least:

a collimator 511, which may be configured as a graded index (GRIN) collimator having both input and output flat sides, where the collimator 511 may be connected/engage (e.g., by splicing) to/with an output end of the optical fiber 501; and

a modification unit 520 that includes a FMS 421 and a SMS 522 forming a distance D therebetween.

According to embodiments, illustrated in FIG. 5, the collimator 511 may be connected (e.g., spliced, adhered, coupled or monolithically formed together with) the modification unit 520, where the FMS 521 may also be connected to (e.g., spliced, adhered, coupled or monolithically formed together with) the SMS 522, such as to form a monolithic single-channeled modification setup 510.

To achieve a monolithic modification setup 510, a (flat) output side/surface of the collimator 511 may be connected/coupled to an input side/surface of the FMS 521 which may include a phase/diffractive mask 521a formed thereover or therein for performing a first modification to the collimated input beam passed therethrough. A (flat) output side/surface FMS 521 may be connected to a (flat) input side/surface of the SMS 522, where an output side/surface of the SMS 522 may have a second phase/diffractive mask 522a embossed/engraved thereover.

FIG. 6 shows a “multi-channel” optical setup 6000, for a coherent beam combining (CBC) system that uses a monolithic or semi-monolithic modification setup for modifying multiple coherent diffraction, according to some embodiments. The optical setup 6000 may include at least:
(a) an optical fiber 6001; and
(b) a multi-channel monolithic modification setup 6100 that may include at least:

a collimation array 6110, including multiple collimation segments, each collimation segment may be configured as a graded index (GRIN) collimator; and

a modification array 6120 that includes a FA 6121 comprising multiple FMSs and a SA 6122 comprising multiple SMSs forming a distance D between the FA 6121 and the SA 6122.

According to embodiments, illustrated in FIG. 6, each collimation segment of the collimation array 6110 may be connected (e.g., spliced, adhered, coupled or monolithically formed together with) the input side/surface of a corresponding FMS of the FA 6121 which may include a phase/diffractive mask 6121a formed thereover or therein for performing a first modification to the corresponding collimated input beam passed therethrough. An output side/surface of each FMS of the FA 6121 may be connected to an input side/surface of a corresponding SMS of the SA 6122, where an output side/surface of each SMS of the SA 6122 may have a second phase/diffractive mask 6122a embossed/engraved thereover.

According to some embodiments, phase/diffractive/optical masks of each FMS and/or SMS may be obtained by using a vaporization and curing-based engraving methods. For example, at least one side of the FMS/SMS may include an anti-reflective coating, where the AR coating is vaporized to form the desired phase mask inscription (embossment/engraving).

FIGS. 7A and 7B shows NF energy distribution of multiple beams having a Gaussian beam profile of a first Gaussian order GO=1 (FIG. 7A) and of a second higher Gaussian order GO=10 (FIG. 7B) that are arranged in a hexagonal formation. The highest energy is represented in dark red color and the lowest in dark blue. In this hexagonal formation it is shown that the gaps between adjacent optical beams (i.e., areas of no or low energy/power/intensity) are much larger when the Gaussian order is low than the gaps of the beams of the higher Gaussian order. This means that using output beams for CBC, for example, that are of a higher Gaussian order (preferably of order that is above GO=5), will enable achieving improved PIB (smallest achievable light spot and highest intensity/power/energy in the spot) and reduced energy loss performances of a combined beam in the FF plane, such as shown in FIG. 7C, which simulates resulting light spot of a FF combined optical beam of the output optical beams shown in FIG. 7B having beam profile of a super-Gaussian of a Gaussian order GO=10. The high FF beam performances of the combined optical beams are mainly achieved when using the super-Gaussian conversion, due to the higher filling of a combined-aperture Ac (in this case a hexagonal or semi-hexagonal aperture) of the output optical beams in the NF plane.

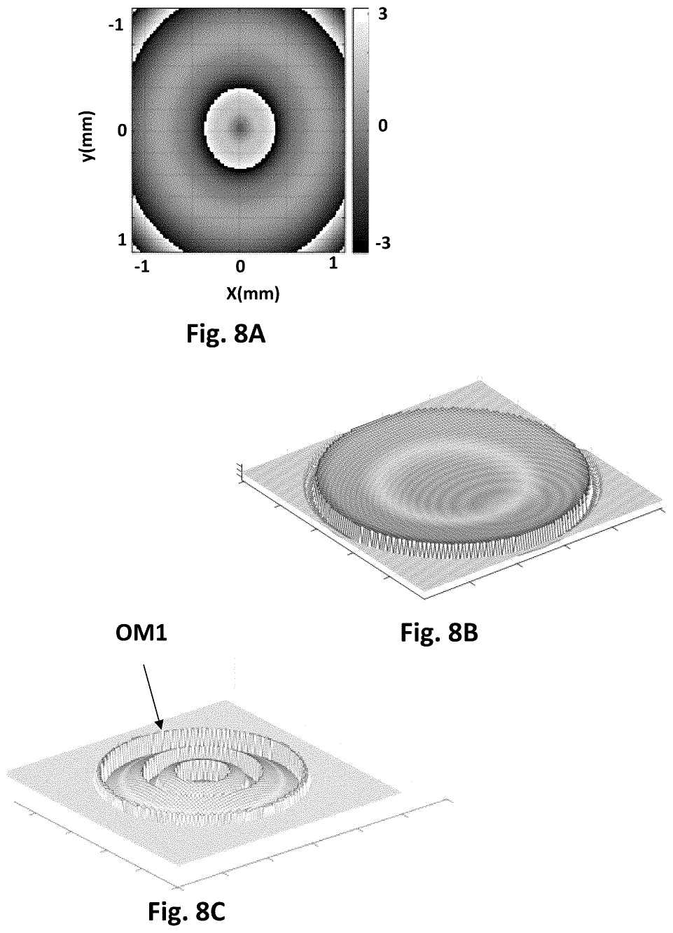

FIGS. 8A-8C show a first diffractive optical/phase mask/diffractive optical element (DOE) OM1 design, according to some embodiments: FIG. 8A shows a spatial phase-distribution (phase-profile) of a Gaussian input beam once converted by the first optical mask OM1 of the modification unit (near the output surface of the first optical mask); FIG. 8B shows an isometric 3D view of the phase-distribution (phase-profile) near the output surface of the first optical mask OM1; and FIG. 8C shows a physical embossment/engraving design of the first phase mask OM1.

As shown in FIG. 8C, according to some embodiments, the design of the first optical mask OM1 may be that of alternating changing thicknesses, such that each concentric ring is of a different thickness (higher/lower) than any of its adjacent ring.

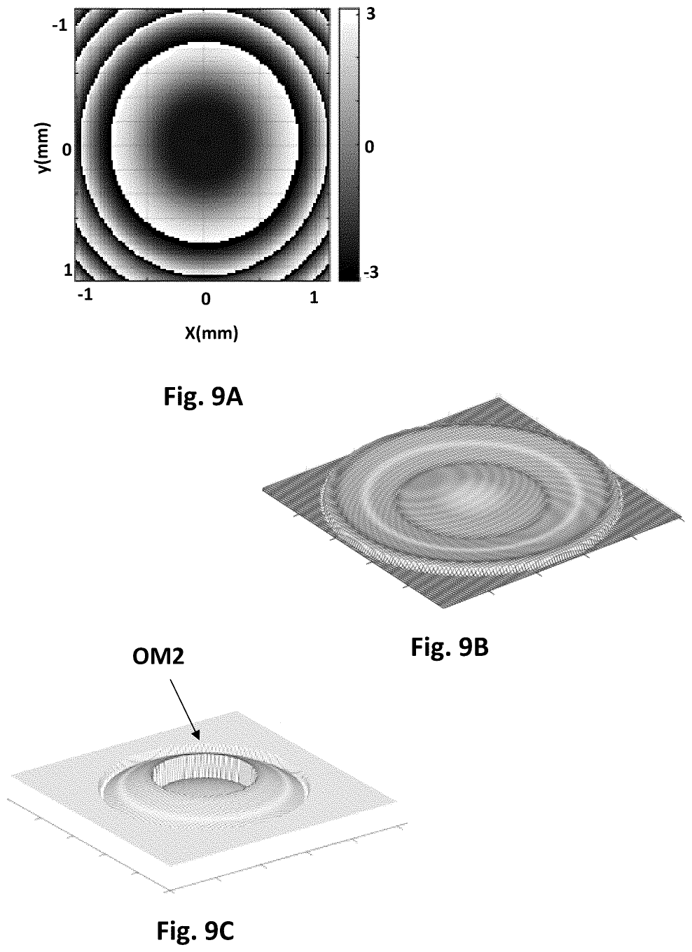

FIGS. 9A-9C show a second diffractive optical mask/DOE OM2 design, according to some embodiments: FIG. 9A shows a spatial phase-distribution (phase-profile) of an intermediate beam of a super Gaussian beam profile once converted by the second phase mask of the modification unit (in the NF, close to the output surface of the surface phase mask); FIG. 9B shows an isometric 3D view of the phase-distribution (phase-profile) near the output surface of the second phase mask; and FIG. 9C shows a physical embossment/engraving design of the second phase mask OM2.

As shown in FIG. 9C, according to some embodiments, the design of the second optical mask OM2 may be such that the thickness of the one or more outer concentric rings is increased then drops at a ring that has a much lower thickness and then gradually increased in thickness for concentric rings approaching the center.

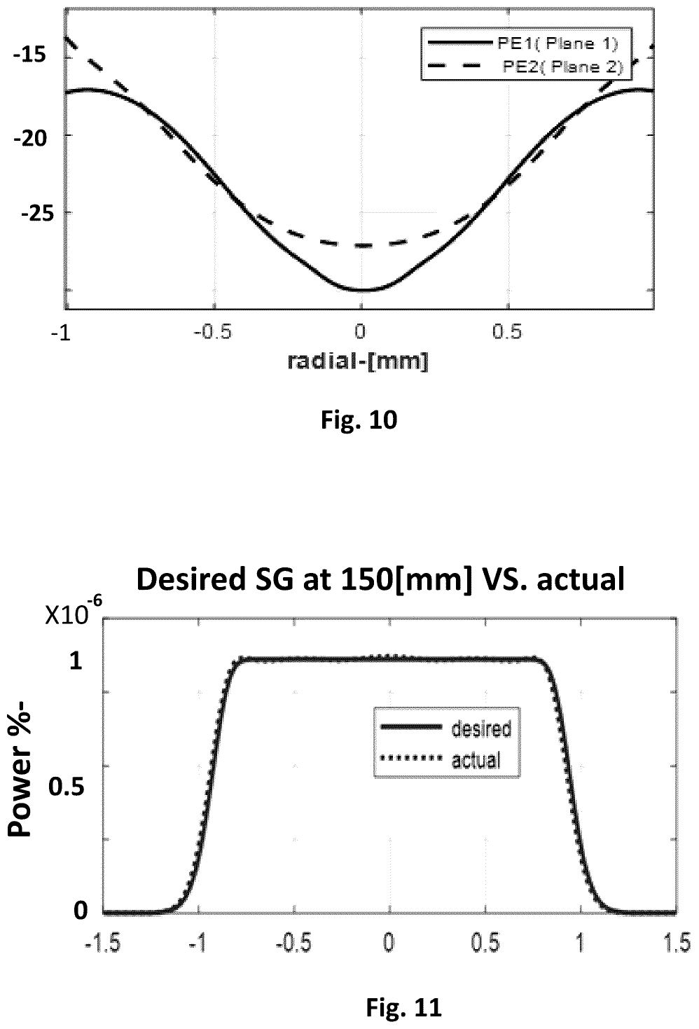

Any one of the first and the second optical mask may be designed as concentric rings causing phases of optical beam parts outputted therefrom change in a radially symmetrical manner, for example, by reducing/increasing in phase towards the center or a main axis of the concentric rings (herein “concentric phase change”), as can be seen in FIG. 10. The reduction/increase of phase between adjacent rings of the first and/or second diffractive optical mask may be, for example equal to or less than an absolute value of Pi: |π|. To achieve such concentric phase change, the concentric rings of the first and/or second diffractive optical mask/s may be designed as having a gradually concentric increasing/decreasing thickness towards the center or main axis of the rings, where the changes in thickness between each pair of adjacent rings may be such that the overall maximal thickness difference between the distal ring (in respect to the center) and the proximal ring, ranges between 1-2 times a wavelength value of the corresponding input optical beam.

FIG. 11 shows a cross section of a super-Gaussian beam profile energy/intensity distribution achieved by using a simulated modification unit of some embodiments.

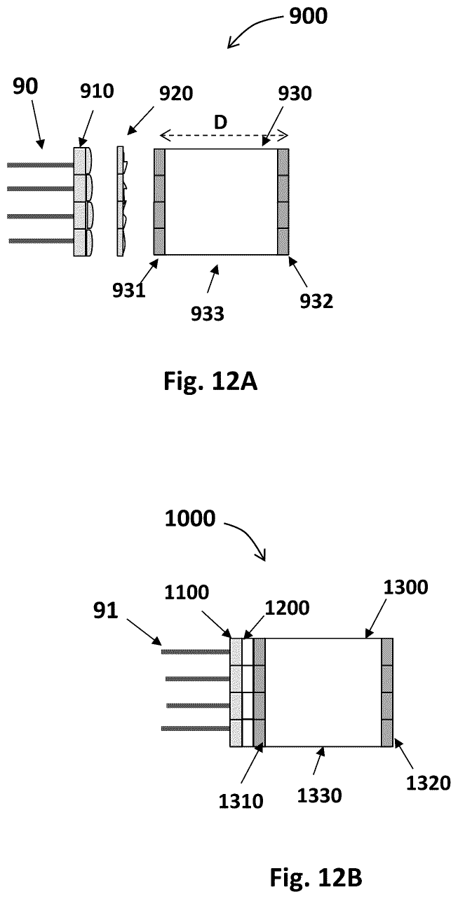

FIG. 12A shows a multi-channel modification setup 900 that also uses a correction array 920 for correcting one or more optical aberrations of optical beams passing through the modification setup 900, according to some embodiments. The modification setup 900 may include at least:

a collimation array 910, including multiple collimation segments, each collimation segment connecting to a different optical fiber of a fiber array 90;

a correction array 920 including multiple correction segments, each correction segment being located and configured to correct one or more optical aberrations/errors e.g., caused due to fiber-to-collimation segment misalignment, manufacturing errors caused due to imperfect manufacturing/fabrication of the respective collimation segment etc.; and

a modification array 930 including a FA 931 including multiple FMSs and a SA 932 including multiple SMSs, where the FA 931 and the SA 932 are spaced from one another forming a distance D therebetween, e.g., via a transparent body 933 connecting at one side thereof to the FA 931 and at another (opposite) side thereof to the SA 932.

FIG. 12B shows a monolithic multi-channel modification setup 1000 that also uses a correction array 1200, according to some embodiments. The modification setup 900 may include at least:

a collimation array 1100, including multiple collimation segments, each collimation segment may be connected/spliced to a different optical fiber of a fiber array 91;

a correction array 1200 including multiple correction segments, each correction segment being located and configured to correct one or more optical aberrations/errors e.g., caused due to fiber-to-collimation segment misalignment, manufacturing errors caused due to imperfect manufacturing/fabrication of the respective collimation segment etc.; and

a modification array 1300 including a FA 1310 including multiple FMSs and a SA 1320 including multiple SMSs, where the FA 1310 and the SA 1320 are monolithically connected to one another via a body 1330 which maintains a constant distance D between the FA 1310 and the SA 1320.

According to some embodiments, as sown in FIG. 12B, an output side of the collimation array 1100 may be monolithically connected to an input side/surface of the correction array 1200, and an output side/surface of the correction array 1200 may be connected to an input side/surface of the modification array 1300.

According to some embodiments, the modification array 930 and/or 1300 may both be configured such that each FMS of the FA 30/1330 thereof is positioned to have maximum light of the corresponding input optical beam passed therethrough and configured to modify an incoming input optical beam such as to form an intermediate optical beam having a beam profile of a Gaussian of a second Gaussian order GO2, which is higher than the first Gaussian order GO1 of the corresponding input optical beam, when the intermediate optical beam reaches a specific formation-distance “d” from an output surface of the first modification segment.

Additionally or alternatively, each SMS of the SA 932/1320 may be positioned in respect to a corresponding FMS may be positioned and configured such that the corresponding intermediate optical beam passes therethrough when its spatial energy distribution of its intermediate beam profile is maximally distributed over a surface area of an effective aperture A2 of the corresponding second modification segment of the SA and with minimum truncating thereof by the corresponding second effective aperture A2. Each SMS may be configured to modify a corresponding intermediate optical beam such as to output a collimated corresponding output optical beam having a planar wavefront and an output beam profile of a Gaussian of the second Gaussian order GO2.

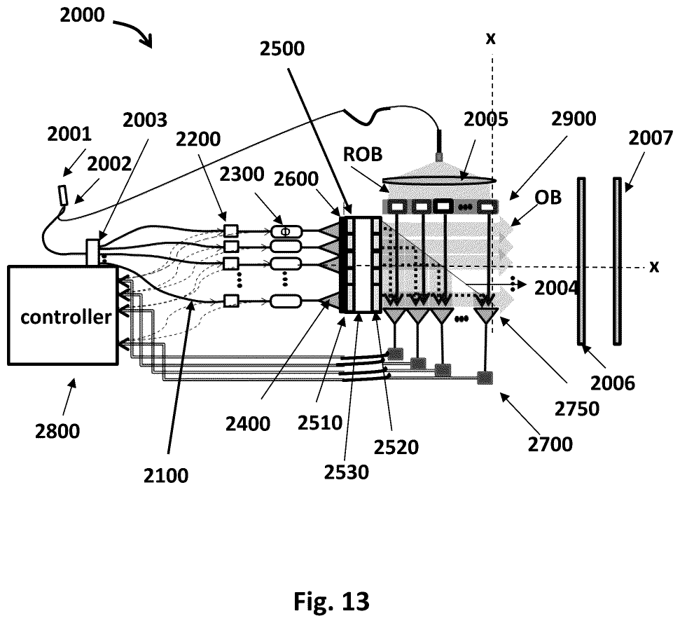

FIG. 13 shows a schematic illustration of a CBC system 2000 that uses a “multi-channel” modification setup having a modification array 2500, for improving FF combined beam performances, according to some embodiments. The CBC system 2000 may include at least:

a light source 2001, such as a diode light source, outputting light at a specific peak WL λ (Lambda);

a first beam splitting/dividing element or device such as first beam splitter (BS) 2002, configured and positioned to divide an original optical beam emanating from the light source 2001 in order to direct some of its radiation to be used as a reference optical beam ROB for measuring various beams interference related properties;

a second beam splitting/dividing element or device such as second beam splitting device (BSD) 2003 used for producing an N number of input optical beams;

a fiber array 2100 comprising at last an N number of optical fibers, each optical fiber being positioned and configured to separately direct a different input optical beam therethrough;

(optionally) a polarization control array 2200, which may include an array of polarization adjusters, each polarization adjuster being positioned and configured for controllable adjustment of polarization of a corresponding input optical beam;

a phase control array 2300, which may include an array of phase shifters, each phase shifter being positioned and configured for controllable adjustment of phase of a corresponding input optical beam;

a collimation array 2400, which may include an array of collimators, each collimator being positioned and configured for collimation of a corresponding input optical beam;

a modification array 2500, which may include an array of modification units, each including a FA 2510 of FMSs and a SA 2520 of SMSs, optionally monolithically connected to one another via a body 2530 maintaining the required distance D therebetween;

one or more correction arrays such as correction array 2600 located before and/or after the modification array 2500, in respect to input optical beams' propagation direction, the correction array 2600 may include an array of correction segments configured and positioned to correct one or more optical errors/aberrations of the input or output optical beams caused due to various mechanical, intrinsic and/or optical causes such as misalignment between various elements such as various one or more arrays 2100/2200/2300/2400/2500 misalignments;

a main BS 2004 for having part of each of the output optical beams, outputted from the CBC system 2000, being propagated in parallel to a main optical axis x and another second part of each input beam being propagated in parallel to a different (e.g., perpendicular) axis y;

a detection array 2700 including an array of detectors such as photodetectors, each detector being configure and positioned to detect light from a different location for measuring one or more properties of an interference signal of a corresponding input optical beam with the reference optical beam ROB for determine various performances related properties of the CBC system 2000;

a lenslet array 2750 of collimators or focusing lenses, each lens of the lenslet array 2750 being positioned and configured to collect light of a different interference signal and direct it towards the corresponding detector; and

a main controller 2800 configured to receive, in real time or near real time updated measurement data/signals from the detection array 2700, process/analyze, in real time or near real time, the received updated measurements signals/data and control at least the phase control array 2400 and the polarization control array 2200, based on analysis/processing results of the received updated signals/data.

As shown in FIG. 13, the CBC system 2000 may be configured such that the reference optical beam ROB, which may be of the same initial optical properties of the light source (i.e., at least same peak WL 2) is directed and optionally manipulated by one or more optical means/elements such as an optical fiber and a collimation lens 2005 such as to as achievably evenly illuminate all output optical beams outputted from the modification array 2500.

According to some embodiments, the illumination propagation direction of the reference optical beam ROB may be aligned with direction of propagation of the second part of output beams (in parallel to axis y. The aligned (parallel) propagation directions of the output beams and the reference beam allows separate measuring the interference signal intensity/pattern in the NF, representing the interference of each output optical beam with a part of the reference optical beam ROB, by using the corresponding detector from the detection array 2700, where the output signal/data outputted from the corresponding detector is indicative of the intensity/power resulting from the interference between the corresponding output beam and the reference beam, which is indicative of the phase difference between the reference phase (phase of the reference beam) and the output phase (phase of the output beam) and also of polarization differences. This is implementable by a feedback loop enabling ongoing continuous simultaneous measuring of all detectors for all N channels of the CBC system 2000 and real time/near real time simultaneous per-channel phase/polarization correction for each input optical beam. Phase and/or polarization adjustment may be made in real time for further improving PIB performances of the FF combined optical beam, e.g., by matching the phases of all channels such that all input beams are of the same phase when exiting the collimation array 2400.

The modification array 2500 ebedded in the CBC system 2000 provides an additional NF and FF CBC performances improvement by preventing or reducing further energy losses and beam(s) divergance.

According to some embodiments, as shown in FIG. 13, the CBC system 2000 may farther include one or more additional optical elements such as elements 2006 and 2007 e.g., for beam shaping/modifying the output combined optical beam in the NF area, for example, for increasing illumination coverage area (energy distribution) of the energy beam profile of the combined output optical beam OB, and/or for changing beam profile shape of the combined output optical beam OB, for the purpose of improving FF performances of the combined output optical beam OB.

According to some embodiments, the CBC system 2000 may farther include a phased array beam steering subsystem using an array of phase modulators (modulation array 2900).

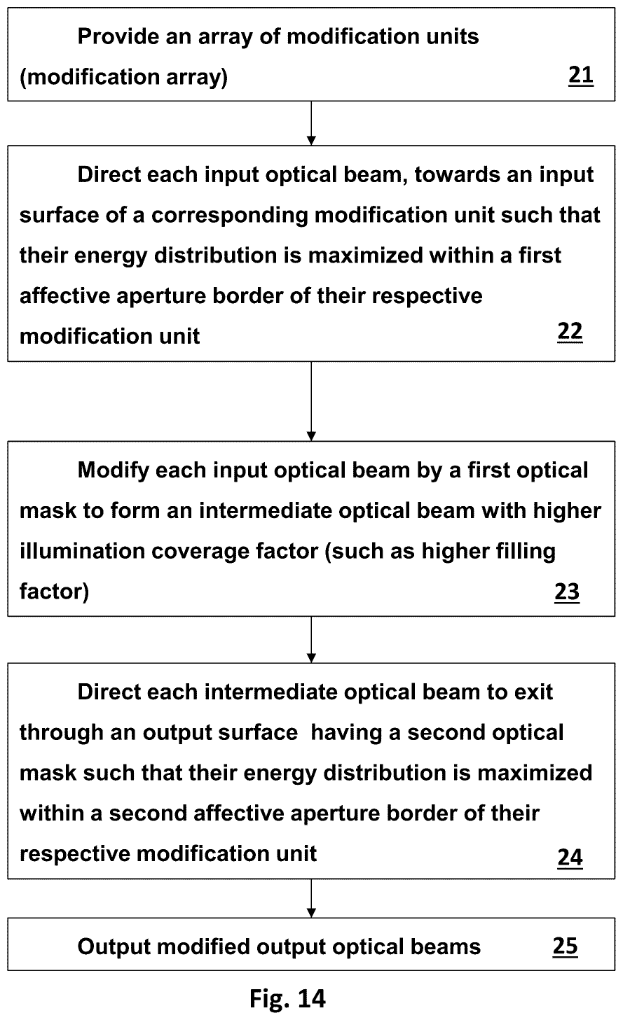

FIG. 14 shows a flowchart of a method/process for modification of multiple input optical beams, according to some embodiments. The method/process may include at least:

providing an array of modification units (modification array) 21;

directing each input optical beam towards an input surface of a corresponding modification unit 22 such that its energy distribution is maximized within borders of a first effective aperture of the respective modification unit and optionally such as to minimize/reduce exceeding of energy of the input optical beam from the corresponding first aperture border (e.g., where the first effective aperture border dimensions are defied by bordering dimensions of a first optical mask through which the input beam is passed); and

modifying each input optical beam by a first optical mask of the corresponding modification unit 23 to form an intermediate optical beam with a higher illumination distribution factor than that of the corresponding input optical beam;

directing the intermediate optical beams to exit through an output surface having a second optical mask 24 such that their energy distribution is maximized within a second affective aperture border; and

Outputting modified output optical beams of minimized/reduced overlap therebetween and maximized/increased spatial energy distribution thereof 25.

According to some embodiments, the second optical mask may be configured both for further phase modification of the incoming intermediate beam and for collimation of the intermediate optical beam such that modification unit can also be used for the actual coherent beam combining (CBC) of the array of input optical beams.

According to some embodiments, the method/process may also include collimate each of the input optical beams, e.g., by using a collimation array comprising multiple collimators, before they enter the modification units' input surface, for improving reduction of energy that exceeds the border of the first effective aperture and improving wavefront and/or phase distribution required from the input optical beams for the specific design of the first optical mask.

According to some embodiments, the modification array may include:

a first array (FA) comprising multiple first modification segments, each first modification segment of the FA being positioned to have a different incoming input optical beam passed therethrough such that the spatial energy distribution of an initial beam profile of the corresponding input optical beam is maximally distributed over a surface area of an effective aperture A1 of the corresponding first modification segment of the FA and causes minimum truncating of the corresponding input optical beam, the corresponding first modification segment being further configured to modify the corresponding input optical beam such as to form an intermediate optical beam having a beam profile of a Gaussian of the second Gaussian order GO2 when the corresponding intermediate optical beam reaches specific formation-distance “d” from a corresponding output surface of the first modification segment; and

a second array (SA) comprising multiple second modification segments, each second modification segment of the SA being positioned in respect to a corresponding first modification segment at a distance D that is equal to or larger than the formation-distance “d” such that the intermediate optical beam passes therethrough when its spatial energy distribution of its intermediate beam profile is maximally distributed over a surface area of an effective aperture A2 of the corresponding second modification segment of the SA and with minimum truncating thereof by the corresponding second effective aperture A2, each second modification segment being configured to modify a corresponding intermediate optical beam such as to output a collimated output optical beam of an output beam profile of a Gaussian of the second Gaussian order GO2.

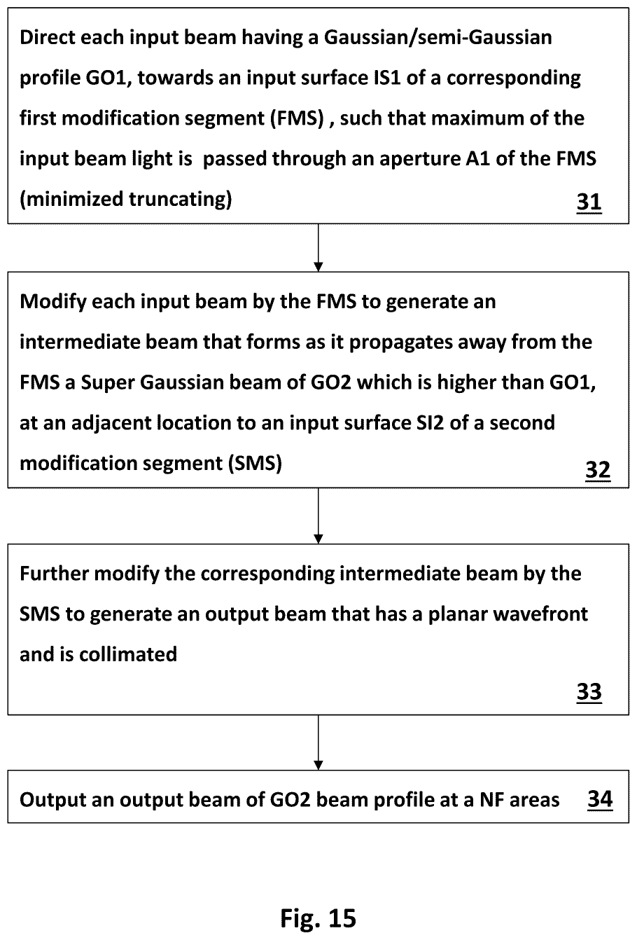

FIG. 15 shows a flowchart of a method/process for modification of at least one input optical beam, according to some embodiments. This method/process may include at least:

providing at least one modification unit;

for each incoming input optical beam and for each modification unit:

directing each input beam having a Gaussian profile GO1, towards an input surface IS1 of a corresponding first modification segment (FMS), such that maximum of the input beam light is passed through an aperture A1 of the FMS yet with minimum/reduced truncating of the input optical beam 31;

modifying each input beam by the FMS to generate an intermediate beam of a higher distribution factor than that of the input optical beam such as a super Gaussian or a semi/pseudo super Gaussian profile of a higher Gaussian order GO2 32;

further modifying the corresponding intermediate beam by the SMS 33 to generate an output beam that has a planar wavefront and is collimated (e.g., having the same beam profile as that of the intermediate beam when reaching the SMS);

Outputting an output optical beam of a higher beam profile (of Gaussian order GO2) 34.

According to some embodiments, each modification unit may be configured such that the output optical beam, outputted therefrom, has a spatial energy distribution, at a NF plane in respect to the modification unit location, that is maximally distributed over an output surface area of an output surface of the modification unit, yet is maximally confined within (minimum truncated by) the second effective aperture of the output surface of the modification unit.

Aspects of disclosed embodiments, pertain to modification arrays and/or modification unit(s) configured for conversion/modification of input optical beam(s) having a beam profile of a radial symmetry (such as a Gaussian beam profile) into output beam(s) of beam profile of improved/maximized energy/intensity spatial distribution with minimum aperture-truncating, that is/are not radially symmetrical (i.e. not of a Gaussian profile) e.g., having a polygonal or semi-polygonal beam profile shape.

In any case or type of modification unit(s)—converting input beam(s) into output beam(s) of a beam profile that has a maximal/higher spatial energy distribution than that of the corresponding input optical beam, the FMS of the modification unit is located/positioned in respect to the input optical beam such that the input optical beam has a maximal energy distribution at an input or output surface of the FMS; and/or the SMS is located and configured such that the intermediate optical beam impinges an inner surface of the SMS when its energy distribution is maximally filling of the SMS aperture A2 with minimal or no energy/intensity truncating of the intermediate optical beam by the aperture A2 of the SMS.

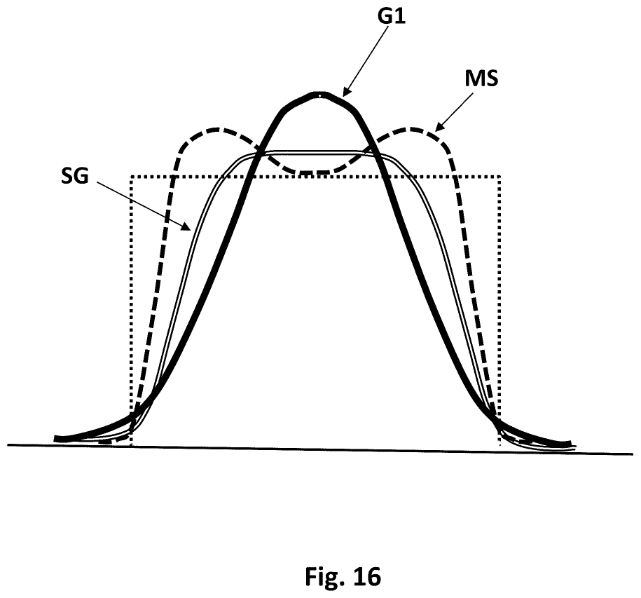

Reference is now made to FIG. 16 schematically illustrating three types of beam profiles:
(i) a super Gaussian profile SG having a substantially wide flattened top;
(ii) a Gaussian profile G1 of a low order (e.g., at least 4 Gaussian orders lower than that of the super Gaussian SG); and
(iii) M-shaped (semi/pseudo-super-Gaussian) cross sectional beam profile MS having a parabolic-shaped indentation of a lowered energy/intensity at its central lobe.

Conversion of input optical beams into M-shaped semi-super-Gaussian profile instead of into a regular super Gaussian may reduce CBC system sensitivity to beam size yet may be increase CBC system sensitivity to misalignments between the first and second optical masks of the modification array, in comparison to the conversion to a super Gaussian profile.

### EXAMPLES

Example 1 is a modification setup for modification of beam profiles of multiple coherent input optical beams, the modification setup comprising at least:

an array of modification units, each modification unit being positioned and configured at least to:

cause light of a corresponding input optical beam to pass through a corresponding input surface of the respective modification unit, in a manner that reduces exceeding of light of the corresponding input optical beam, from a first effective aperture of the corresponding input surface;

modify beam profile of the corresponding input optical beam, to form an intermediate optical beam having an intermediate beam profile that has an illumination distribution factor that is higher than that of the corresponding input optical beam, wherein an output surface of the corresponding modification unit, having a second effective aperture, is located at a distance D from the input surface of the corresponding modification unit such that the corresponding intermediate optical beam passes through the corresponding output surface at increased illumination cover area and decreased exceeding of the corresponding second effective aperture of the corresponding output surface; and

output multiple modified output optical beams of reduced beam-overlap and increased illumination coverage area at a near filed (NF) traversing plane.

In example 2, the modification setup of example 1 may include, wherein each modification unit comprises a first optical mask and a second optical mask located such as to form a distance D therebetween, wherein the first effective aperture is determined by dimensions of the first optical mask and the second effective aperture is determined by dimensions of the second optical mask.

In example 3, the modification setup of example 2 may include, wherein the first optical mask is a diffractive mask and the second optical mask is a diffractive mask of a different design than that of the first diffractive mask.

In example 4, the modification setup of any one or more of examples 2 to 3 may include, wherein the first optical mask is configured to modify a corresponding input optical beam by changing phase-profile thereof, and wherein the corresponding second modification segment is configured at least for further phase-profile modification such as to produce a corresponding collimated output optical beam.

In example 5, the modification setup of any one or more of examples 1 to 4 may include, wherein each of the corresponding input optical beam, intermediate optical beam and output optical beam has a radial symmetry.

In example 6, the modification setup of any one or more of examples 1 to 5 may include, wherein each of the input optical beams has a beam profile of a Gaussian or semi-Gaussian of a first Gaussian order GO1.

In example 7, the modification setup of example 6 may include, wherein each modification unit of the modification setup is configured such as modify each corresponding input optical beam by converting it into a corresponding intermediate optical beam having one of:

a beam profile of a Gaussian of a second Gaussian order GO2 that is higher than the first Gaussian order GO1 of the corresponding input optical beam;

a beam profile of an M-shape semi-Gaussian having a cross sectional shape that comprises a central lowered-energy indentation.

In example 8, the modification setup of example 7 may include, wherein the second Gaussian order GO2 of each intermediate optical beam is higher than the first Gaussian order GO1 of each input optical beam by at least 4 orders.

In example 9, the modification setup of any one or more of examples 1 to 8 may include, wherein the array of modification units comprises at least:

a first array (FA) comprising multiple first modification segments, each first modification segment of the FA comprising a first optical mask; and

a second array (SA) comprising multiple second modification segments, each second modification segment of the SA comprising a second optical mask.

In example 10, the modification setup of any one or more of examples 1 to 9 may include, wherein each modification unit is positioned in optical alignment with each corresponding incoming input optical beam.

In example 11, the modification setup of any one or more of examples 1 to 10 may include, wherein the value of distance D is higher than or equal to a distant threshold value Dth that is determined based on wavelength value of the input optical beams and size of the first effective aperture.

In example 12, the modification setup of any one or more of examples 1 to 11 may include, wherein each of the input optical beams is directed to a different input surface of a different modification unit via a different optical fiber, wherein the location of the light source of each input optical beam is a corresponding output end of the corresponding optical fiber.

In example 13, the modification setup of example 12 may include, wherein each optical fiber is directly or indirectly optically coupled, connected or directed to a corresponding input surface of a corresponding modification unit.

In example 14, the modification setup of any one or more of examples 1 to 13 my include, wherein the modification setup further comprises a collimation array (CA) comprising multiple collimators, The CA being positioned between light sources from which the input optical beams emanate and input surfaces of the modification units, wherein each collimator of the CA is configured and positioned to collimate a corresponding input optical beam before it reaches the input surface of the corresponding modification unit.

In example 15, the modification setup of example 14 may include, wherein the CA is monolithically combined with or coupled to an input side of the modification array, such that each collimator of the CA is connected to or engages a corresponding input surface of the corresponding modification unit.

In example 16, the modification setup of any one or more of examples 1 to 15 may include, wherein all parts of the modification setup are monolithically connected to none another either directly or via other one or more connecting elements.

In example 17, the modification setup of any one or more of examples 1 to 16 may include, wherein the modification setup is embedded in a coherent beam combining (CBC) system configured for combining of the input optical beams for improving far field (FF) performances of a combined output beam pertaining at least to FF power in the bucket (PIB) performances of the combined output beam.

In example 18, the modification setup of example 17 may include, wherein the CBC system further comprises at least one of: one or more light sources; at least one array of optical fibers producing the input optical beams; at least one array of collimators for collimating the input optical beams before impinging the modification units of the modification setup; a phase control subsystem for real time or near real time measuring phase of each of the output and/or the input optical beams, and real time or near real time adjusting phase of each input optical beam, based on its corresponding measured real time or near real time measured phase; a beam steering subsystem for phased array or mechanical based steering of the combined optical beam; one or more optical elements for combining and/or for focusing the output optical beams, outputted from the modification setup; one or more optical elements for directing light illuminated by the one or more light source into each of the optical fibers; a polarization control subsystem for real time or near real time measuring polarization of each of the output and/or the input optical beams, and real time or near real time adjusting polarization of each input optical beam, based on its corresponding measured real time or near real time measured polarization; a customized passive/active correction subsystem for correction of optical aberrations formed by any one or more of the arrays, elements, optical fibers, and/or subsystems of the CBC system and/or by any one or more erroneous alignment therebetween; an active corrections subsystem for active real time or near real time measuring and correction of optical aberrations formed by deformation of any one or more of the arrays, elements, optical fibers, and/or subsystems of the CBC system and/or by any one or more erroneous alignment therebetween.

Example 19 is a method for modification of beam profiles of multiple coherent input optical beams, the method comprising at least:

providing an array of modification units, each modification unit having an input surface with a first effective aperture and an output surface with a second effective aperture, wherein each output surface is located at a distance D from its corresponding input surface;

causing light of each input optical beam to pass through a corresponding input surface of a corresponding modification unit, in a manner that reduces exceeding of light of the corresponding input optical beam, from a corresponding first effective aperture of the corresponding input surface;

modifying beam profile of each input optical beam, to form an array of intermediate optical beams, each intermediate optical beam having an intermediate beam profile that has an illumination distribution factor that is higher than that of its corresponding input optical beam, each intermediate optical beam is passed between from the input surface to the output surface of the corresponding modification unit such that the intermediate optical beam passes through the corresponding output surface at increased illumination cover area and decreased exceeding of the corresponding second effective aperture of the corresponding output surface; and

outputting multiple modified output optical beams of reduced beam-overlap and increased illumination coverage area at a near filed (NF) traversing plane.

In example 20, the method of example 19 may include, wherein each of the input optical beams, the intermediate optical beams and the output optical beams is of a radial symmetry, wherein the beam profile of each output optical beam is similar or same as that of its corresponding intermediate optical beam.

In example 21, the method of example 20 may include, wherein each input optical beam is of a Gaussian or semi-Gaussian beam profile of a first Gaussian order GO1, and wherein each modification unit is configured to convert each input optical beam to an intermediate optical beam having one of: a Gaussian or semi-Gaussian beam profile of a Gaussian order GO2 that is higher than the first Gaussian order GO1, or a M-shaped cross sectional beam profile.

In example 22, the method of any one or more of examples 19 to 21 may include, wherein each input optical beam is collimated by a collimator before entering a corresponding input surface of a corresponding modification unit.

Example 23 is a modification unit for modification of beam profile of an input optical beam, the modification unit comprising at least:

a first optical mask configured and located o cause an input optical beam to pass through an input surface thereof, in a manner that reduces exceeding of light of the corresponding input optical beam, from a first effective aperture of the corresponding input surface and to modify beam profile of the passed input optical beam, to form an intermediate optical beam having an intermediate beam profile that has an illumination distribution factor that is higher than that of the corresponding input optical beam; and

a second optical mask having an output surface with a second effective aperture, that is located at a distance D from the input surface of the corresponding modification unit such that the intermediate optical beam passes through the output surface of the second optical mask at increased illumination cover area and decreased exceeding of the second effective aperture.

In example 24, the modification unit of example 23 may include, wherein the first optical mask is a diffractive mask and the second optical mask is a diffractive mask of a different design than that of the first diffractive mask.

In example 25, the modification unit of any one or more of examples 23 to 24 may include, wherein the first optical mask is configured to modify the input optical beam by changing phase-profile thereof, and wherein the corresponding second modification mask is configured at least for further phase-profile modification such as to produce a collimated output optical beam.

In example 26, the modification unit of any one or more of examples 23 to 25 may include, wherein each of the input optical beam, the intermediate optical beam and the output optical beam has a radial symmetry.

In example 27, the modification unit of any one or more of examples 23 to 26 may include, wherein the input optical beam has a beam profile of a Gaussian or semi-Gaussian of a first Gaussian order GO1.

In example 28, the modification unit of example 27 may include, wherein the modification unit is configured to modify the input optical beam by converting it into a corresponding intermediate optical beam having one of: a beam profile of a Gaussian of a second Gaussian order GO2 that is higher than the first Gaussian order GO1 of the corresponding input optical beam; a beam profile of an M-shape semi-Gaussian having a cross sectional shape that comprises a central lowered-energy indentation.

In example 29, the modification unit of example 28 may include, wherein the second Gaussian order GO2 of each intermediate optical beam is higher than the first Gaussian order GO1 of each input optical beam by at least 4 orders.

In example 30, the modification unit of any one or more of examples 23 to 29 may include, wherein the value of distance D is higher than or equal to a distant threshold value Dth that is determined based on wavelength value of the input optical beams and size of the first effective aperture.

In example 31, the modification unit of any one or more of examples 23 to 30 may include, wherein the modification unit further comprises a collimator, positioned between a light source from which the input optical beam emanates and the input surfaces of the first optical mask, the collimator being configured and positioned to collimate a corresponding input optical beam before it reaches the input surface of the first optical mask.

In example 32, the modification unit of example 31 may include, wherein the collimator is monolithically combined with or coupled to an input side of the modification unit, such that it is connected to or engages the input surface of the optical mask.

In example 33, the modification unit of any one or more of examples 23 to 32 may include, wherein all parts of the modification unit are monolithically connected to one another either directly or via other one or more connecting elements.

Example 34 is a method for modification of beam profiles of input optical beams, the method comprising at least:

providing at least one modification unit having an input surface with a first effective aperture and an output surface with a second effective aperture, wherein each output surface is located at a distance D from its corresponding input surface;

causing light of each input optical beam to pass through a corresponding input surface of a corresponding modification unit, in a manner that reduces exceeding of light of the corresponding input optical beam, from a corresponding first effective aperture of the corresponding input surface;

modifying beam profile of each input optical beam, to form a corresponding intermediate optical beam having an intermediate beam profile that has an illumination distribution factor that is higher than that of its corresponding input optical beam, each intermediate optical beam is passed between from the input surface to the output surface of the corresponding modification unit such that the intermediate optical beam passes through the corresponding output surface at increased illumination cover area and decreased exceeding of the corresponding second effective aperture of the corresponding output surface; and

outputting multiple modified output optical beams of reduced beam-overlap and increased illumination coverage area at a near filed (NF) traversing plane.

In example 35, the modification unit of example 34 may include, wherein each of the input optical beams, the intermediate optical beams and the output optical beams is of a radial symmetry, wherein the beam profile of each output optical beam is similar or same as that of its corresponding intermediate optical beam

In example 36, the modification unit of example 35 may include, wherein each input optical beam is of a Gaussian or semi-Gaussian beam profile of a first Gaussian order GO1, and wherein each modification unit is configured to convert each input optical beam to an intermediate optical beam having one of: a Gaussian or semi-Gaussian beam profile of a Gaussian order GO2 that is higher than the first Gaussian order GO1, or a M-shaped cross sectional beam profile.

In example 37, the modification unit of any one or more of examples 34 to 36 may include, wherein each input optical beam is collimated by a collimator before entering a corresponding input surface of a corresponding modification unit.

Although the above description discloses a limited number of exemplary embodiments of the invention, these embodiments should not apply any limitation to the scope of the invention, but rather be considered as examples of some of the manners in which the invention can be implemented.

Parts of the systems and/or methods described above may be implementable via a computer readable medium, requiring computerized executable instructions, rules, conditions, memory, etc. from programmable hardware and/or software based means such executable modules, and therefore can be considered as including/using a “special purpose computer”.

Methods/processes and/or systems/devices/subsystems/apparatuses etc., disclosed in the above Specification, are not to be limited strictly to flowcharts, block diagrams and/or graphs provided in the Drawings.

Terms used in the singular may also include a plural scope, except where expressly stated as otherwise.

In the description and claims of the present application, each of the verbs, “comprise” “include” and “have”, and conjugates thereof, are used to indicate that the component(s) and/or process/method described include/have/comprise at least one of the listed components/steps/features etc. and/or at least the listed components/steps/features etc.

1. A modification setup for modification of beam profiles of multiple coherent optical beams, for a coherent beam combining (CBC) system, the modification setup comprising at least:
(i) an array of modification units (modification array), each modification unit comprising an input surface having a first effective aperture and an output surface having a second effective aperture, wherein the input and output surfaces are located at a distance D from one another, each modification unit being positioned and configured at least to:
modify beam profile of an entering optical beam, to form an intermediate optical beam having an intermediate beam profile that has an illumination distribution factor that is higher than that of the corresponding input optical beam, such that the corresponding intermediate optical beam passes through the corresponding output surface at increased illumination cover area and decreased exceeding of light of the optical beam from the corresponding second effective aperture of the corresponding output surface; and
output multiple modified output optical beams of reduced beam-overlap and increased illumination coverage area at a near filed (NF) traversing plane; and
(ii) a collimation array (CA) comprising an array of collimators, wherein each collimator of the CA is configured and positioned to collimate a corresponding input optical beam before it reaches the input surface of the corresponding modification unit,
wherein each collimator of the CA is positioned in respect to the input surface of its corresponding modification unit such as to cause light of a corresponding collimated input optical beam to pass through a corresponding input surface of the respective modification unit, in a manner that reduces exceeding of light of the corresponding collimated input optical beam, from the first effective aperture of the corresponding input surface,
wherein each modification unit is configured such as to modify each corresponding input optical beam by converting it into a corresponding output optical beam, which has a radial symmetry and an M-shape beam profile cross-section such that the beam profile comprises a central lowered-energy indentation.

2. The modification setup of claim 1, wherein each modification unit comprises a first optical mask and a second optical mask located such as to form a distance D therebetween, wherein the first effective aperture is determined by dimensions of the first optical mask and the second effective aperture is determined by dimensions of the second optical mask.

3. The modification setup of claim 2, wherein the first optical mask is a diffractive mask and the second optical mask is a diffractive mask of a different design than that of the first diffractive mask.

4. The modification setup of claim 2, wherein the first optical mask is configured to modify a corresponding input optical beam by changing phase-profile thereof, and wherein the corresponding second modification segment is configured at least for further phase-profile modification such as to produce a corresponding collimated output optical beam.

5. (canceled)

6. The modification setup of claim 1, wherein each of the input optical beams has a beam profile of a Gaussian or semi-Gaussian of a first Gaussian order GO1.

7. The modification setup of claim 6, wherein each modification unit of the modification setup is configured such as modify each corresponding input optical beam by converting it into a corresponding intermediate optical beam having one of:
a beam profile of a Gaussian of a second Gaussian order GO2 that is higher than the first Gaussian order GO1 of the corresponding input optical beam;
a beam profile of an M-shape semi-Gaussian having a cross sectional shape that comprises a central lowered-energy indentation.

8. (canceled)

9. The modification setup of claim 1, wherein the array of modification units comprises at least:
a first array (FA) comprising multiple first modification segments, each first modification segment of the FA comprising a first optical mask; and
a second array (SA) comprising multiple second modification segments, each second modification segment of the SA comprising a second optical mask.

10. The modification setup of claim 1, wherein each modification unit is positioned in optical alignment with each corresponding incoming input optical beam.

11. The modification setup of claim 1, wherein the value of distance D is higher than or equal to a distant threshold value Dth that is determined based on wavelength value of the input optical beams and size of the first effective aperture.

12. The modification setup of claim 1, wherein each of the input optical beams is directed to a different input surface of a different modification unit via a different optical fiber of a fiber array, wherein the location of the light source of each input optical beam is a corresponding output end of the corresponding optical fiber of the fiber array.

13. The modification setup of claim 12, wherein each optical fiber is directly or indirectly optically coupled, connected or directed to a corresponding input surface of a corresponding modification unit.

14. The modification setup of claim 1, wherein the CA is monolithically combined with or coupled to an input side of the modification array, such that each collimator of the CA is connected to or engages a corresponding input surface of the corresponding modification unit of the modification array.

15. The modification setup of claim 1, wherein at least some parts of the modification setup are coupled or connected to one another.

16. The modification setup of claim 1, wherein the modification setup is embedded in the coherent beam combining (CBC) system configured for combining of the input optical beams for reducing energy losses and/or for improving far field (FF) performances of a combined output beam pertaining at least to FF power in the bucket (PIB) performances of the combined output beam.

17. The modification setup of claim 16, wherein the CBC system further comprises at least one of:
one or more light sources;
at least one fiber array of optical fibers producing the input optical beams;
a phase control subsystem comprising a phase control array, the phase control subsystem being configured for real time or near real time measuring phase of each of the output and/or the input optical beams, and real time or near real time adjusting phase of each input optical beam, based on its corresponding measured real time or near real time measured phase;
a beam steering subsystem for phased array or mechanical based steering of the combined optical beam;
one or more optical elements for combining and/or for focusing the output optical beams, outputted from the modification setup;
one or more optical elements for directing light illuminated by the one or more light source into each of the optical fibers;
a polarization control subsystem comprising a polarization control array, the polarization control subsystem being configured for real time or near real time measuring polarization of each of the output and/or the input optical beams, and real time or near real time adjusting polarization of each input optical beam, based on its corresponding measured real time or near real time measured polarization;
a customized passive/active correction subsystem for correction of optical aberrations formed by any one or more of the arrays, elements, optical fibers, and/or
subsystems of the CBC system and/or by any one or more erroneous alignment therebetween;
an active corrections subsystem for active real time or near real time measuring and correction of optical aberrations formed by deformation of any one or more of the arrays, elements, optical fibers, and/or subsystems of the CBC system and/or by any one or more erroneous alignment therebetween.

18. A method for modification of beam profiles of multiple coherent optical beams, the method comprising at least:
providing an array of modification units (modification array), each modification unit having an input surface with a first effective aperture and an output surface with a second effective aperture, wherein each output surface is located at a distance D from its corresponding input surface;
providing a collimation array (CA) comprising an array of collimators, positioned before the array of modification units of the modification array;
collimating each input optical beam by its corresponding collimator of the CA for causing light of each input optical beam to be collimated before entering its corresponding input surface of its corresponding modification unit;
modifying beam profile of each entering collimated input optical beam, to form an array of intermediate optical beams, each intermediate optical beam having an intermediate beam profile that has an illumination distribution factor that is higher than that of its corresponding collimated input optical beam, each intermediate optical beam is passed from the input surface to the output surface of the corresponding modification unit such that the intermediate optical beam passes through the corresponding output surface at increased illumination cover area and decreased exceeding of light of the intermediate optical beam from the corresponding second effective aperture of the corresponding output surface; and
outputting multiple modified output optical beams of reduced beam-overlap and increased illumination coverage area at a near filed (NF) traversing plane,
wherein each collimator of the CA is positioned in respect to the input surface of its corresponding modification unit such as to cause light of a corresponding collimated input optical beam to pass through a corresponding input surface of the respective modification unit, in a manner that reduces exceeding of light of the corresponding collimated input optical beam, from the first effective aperture of the corresponding input surface,
wherein each modification unit is configured such as to modify each corresponding input optical beam by converting it into a corresponding output optical beam, which has a radial symmetry and an M-shape beam profile cross-section such that the beam profile comprises a central lowered-energy indentation.

19. The method of claim 18, wherein each of the input optical beams, the intermediate optical beams and the output optical beams is of a radial symmetry, wherein the beam profile of each output optical beam is similar or same as that of its corresponding intermediate optical beam.

20-33. (canceled)

34. The method of claim 18, wherein the modification array and the CA are embedded in a coherent beam combining (CBC) system configured for combining of the input optical beams for reducing energy losses and/or for improving far field (FF) performances of a combined output beam pertaining at least to FF power in the bucket (PIB) performances of the combined output beam.

35. The method of claim 34, wherein the CBC system further comprises at least one of:
one or more light sources;
at least one fiber array of optical fibers producing the input optical beams;
a phase control subsystem comprising a phase control array, the phase control subsystem being configured for real time or near real time measuring phase of each of the output and/or the input optical beams, and real time or near real time adjusting phase of each input optical beam, based on its corresponding measured real time or near real time measured phase;
a beam steering subsystem for phased array or mechanical based steering of the combined optical beam;
one or more optical elements for combining and/or for focusing the output optical beams, outputted from the modification setup;
one or more optical elements for directing light illuminated by the one or more light source into each of the optical fibers;
a polarization control subsystem comprising a polarization control array, the polarization control subsystem being configured for real time or near real time measuring polarization of each of the output and/or the input optical beams, and real time or near real time adjusting polarization of each input optical beam, based on its corresponding measured real time or near real time measured polarization;
a customized passive/active correction subsystem for correction of optical aberrations formed by any one or more of the arrays, elements, optical fibers, and/or
subsystems of the CBC system and/or by any one or more erroneous alignment therebetween;
an active corrections subsystem for active real time or near real time measuring and correction of optical aberrations formed by deformation of any one or more of the arrays, elements, optical fibers, and/or subsystems of the CBC system and/or by any one or more erroneous alignment therebetween.
